(19) United States
(12) Patent Application Publication
(10) Pub. No.: US 2008/0240330 A1
(43) Pub. Date: Oct. 2, 2008

(54) Compact Device for Dual Transmutation for Isotope Production Permitting Production of Positron Emitters, Beta Emitters and Alpha Emitters Using Energetic Electrons

(76) Inventor: CHARLES S. HOLDEN, SAN FRANCISCO, CA (US)

Correspondence Address: STAINBROOK & STAINBROOK, LLP, 412 AVIATION BOULEVARD, SUITE H, SANTA ROSA, CA, 95403, US

(21) Appl. No.: 12/015,408

(22) Filed: Jan. 16, 2008

Related U.S. Application Data
(60) Provisional application No. 60/885,276, filed on Jan. 17, 2007.

(51) Int. Cl. G21G 1/00

(52) U.S. Cl. 376/190

(57) ABSTRACT

A method and apparatus for directing high energy electrons to a converter material that emits gamma rays, which, in turn interact directly with parent isotopes to produce unstable, short-lived medical isotopes and product isotopes by the gamma, n reaction, or which interact with high-z materials to produce neutrons that then produce valuable isotopes by neutron capture in parent isotopes.

### CROSS REFERENCES TO RELATED APPLICATIONS

The present application claims the benefit of U.S. Provisional Patent Application Ser. No. 60/885,276, filed Jan. 17, 2007, (Jan. 17, 2007).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to methods and apparatus for producing nuclear isotopes, and more particularly to a novel device that employs two methods to produce commercial quantities of valuable medical and commercial isotopes. Still more particularly, the present invention relates to a method and apparatus for receiving high energy electrons that impact a converter material, that emits gamma rays that interact directly with parent isotopes to produce unstable, short-lived medical isotopes and product isotopes by the gamma, n reaction, or which gammas interact with high-z materials, such as lead, thorium, and bismuth, to produce neutrons that in turn produce valuable isotopes by neutron capture in parent isotopes.

2. Discussion of Related Art including information disclosed under 37 CFR §§1.97, 1.98

The known prior art reveals that the present invention advances technical knowledge in the field in ways unforeseen by the inventors of the methods and apparatus disclosed in the patents and patent applications discussed below. Unlike the prior art systems, the method and apparatus of the present invention provides means for concurrently producing many isotopes in a single radiation cycle.

International Patent Application WO91/13443, by Van Geel et al, teaches a procedure for producing actinium-225 and bismuth-213. Among other things it describes the medical importance of Actinium-225 and Bismuth-213. The disclosed technique involves irradiating radium-226 with thermal neutrons to produce Thorium-229, which decays to Radium-225 and then to Actinium-225. This method differs from those of the present invention because neutrons are added to the nuclei of radium-226, whereas the present invention describes a method of using gamma radiation to eject one neutron from the nuclei of various precursor isotope radium-226 to produce Actinium-225 and others by the same technique, e.g., copper-65 to copper-64, oxygen-16 to oxygen-15, and so forth.

European Patent EP 0752 710, to Koch et al, describes a method of producing Actinium-225 from Radium-226 by the n, 2n process is disclosed. In this disclosure higher energy neutrons are used to synthesize Actinium-225 from Radium-226. The method of the present invention employs a different production device and different process that uses gamma photons and no energetic neutrons.

European Patent EP 0 962 942, to Apostolidis et al, teaches a method of producing Actinium-225 by irradiation of Radium-226 with protons. The protons are accelerated in a cyclotron to a range of 14-17 MeV and the Radium-226 target is irradiated. The present application utilizes a different device and production process that employs gamma photons and no protons.

European Patent Application EP 1453 063 A1, by Magill et al, discloses a method of producing Actinium-225 by a high intensity laser. A laser is used to produce relativistic electrons that interact with a converter material to produce gamma photons that then interact with radium-226. Also disclosed is a method by which the laser accelerates protons which interact with radium-226. The two methods do not use electrons accelerated into a beam that interacts with a novel converter alloy, as is disclosed in the instant application.

European Patent Application EP 1 455 364, by Abbas et al, describes a method of producing Actinium-225 by using accelerated deuterons. The method uses a cyclotron to accelerate deuterons that impact or bombard a radium-226 target comprised of radium-226 chloride. The Abbas application does not disclose a method of producing Actinium-226 using gamma photons for transmutation.

U.S. Pat. No. 6,208,704, to Lidsky et al, discloses the general concept that an electron beam can be used to create gamma photons and that the gamma photons can then be directed to a target of a precursor isotope. The exemplary transmutation in the '704 patent uses gamma radiation to eject neutrons to produce a commercially important medical isotope and involves Technetium-99m, which is a decay product of Molybdenum-99 produced from Molybdenum-100 by gamma photons. The '704 patent does not disclose any electron to gamma converter material except tungsten, nor a device having two or more chambers allowing for cooling. Further the '704 does not disclose a two parent target material that is comprised of two or more materials, each of which can be transmuted to useful quantities of medical isotopes at the time same. Further, the '704 patent does not disclose a composite target shaped into disks, oblate spheroids or beads (either hollow or solid) that can be cooled by liquids or gasses during irradiation. In summary, the '704 patent is essentially a report on a general principal of physical science, commonly known to students of nuclear reactions, that sufficiently energetic and penetrating gamma photons eject neutrons from all isotopes of all elements.

By contrast, the instant application teaches novel combinations of materials that produce significant quantities of valuable isotopes when irradiated with gamma photons. The geometry of the inventive apparatus permits a large heat flow to be managed. The small beads, disks or oblate spheroids pack space with different efficiencies allowing the selected gas cooling or liquid cooling that is optimized by the heat flux produced by the incident electrons that are managed by the two or more chambers in the target assembly.

U.S. Pat. No. 6,680,993 B2, to Satz and Schenter, shows a general method of producing medical isotopes by the use of gamma radiation, in a manner more detailed than that of the '704 patent, discussed above. The '993 patent discloses the use of energetic and penetrating gamma photons to produce Actinium-225 from Radium-226 and reveals the benefits of using gamma radiation for the production of Actinium-225 over many of the methods then known in the art. It teaches directing an electron beam to a converting material plated with Radium-226. The converting material is Copper, Tungsten, Platinum and/or Tantalum, and Radium is plated to the converter material in a thickness of 0.5 mm to about 1.7 mm. However, the disclosed method inadequately manages head from the electron beam. The heat from a continuous irradiation of tens to hundreds of hours in duration will cause radium plated to the converter to melt and vaporize. The melting point and boiling point of radium are 700 degrees C. and 1737 degrees C., respectively. The converter that receives the accelerated electrons and slows them down must be an optimized refractory alloy capable of managed heat transfer, high heat flow and continuous service during an optimal irradiation having a 40-day duration. The heat from the electron beam will promptly vaporize tungsten. Tungsten vaporizes at a much higher temperature than radium. Heat management must be a main topic of consideration in the apparatus that uses the gamma, n method of producing medical or other commercial isotopes.

Accordingly to advance the art of the gamma, n method shown in the '993 patent, the present invention addresses heat transport and teaches a method able to produce commercial quantities of many desirable products. The present invention advances the art and makes the gamma, n transmutation process more practical and productive both for the addition or subtraction of neutrons from nuclei. In contrast to the method taught in the '993 patent, radium or other precursor isotope is not plated to the converter that produces the vast majority of the gamma photons. The converter is a separate feature that has been optimized for heat transport, heat export out of the converter. Further, in contrast the target beads are arrayed so that the selected coolant or working fluid can rapidly be pumped through the target capsule to prevent the target capsule from being degraded by thermal effects.

The foregoing patents and patent application reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The method and apparatus of the present invention advance the art of isotope production using novel electron to gamma converter materials, novel coolants, and novel geometries for target isotopes and novel types of targets to make useful commercial, industrial or medical isotopes. The method exploits the gamma, n reaction that ejects one neutron from the nuclei of numerous, selected precursor isotopes to be exposed to a flux of gamma photons.

In the most essential terms, the inventive system comprises an electron beam source, a gamma conversion device, and a heat managed isotope production target system assembled in a computationally optimized geometry and employing computationally optimized materials. The most favorable configuration for isotope production is to locate the gamma source as close to the target material as possible, and as such this would place the target material within the gamma source. However, this arrangement would expose the target to high heat generated by the electron beam and could damage the target assemblies and force limits on the duration of the irradiation cycle. The present invention provides a solution to this problem by segregating the gamma source chamber from the target material chamber and to provide dedicated cooling systems for each chamber. In a first chamber, an electron-to-gamma converter (also referred to herein as a “gamma converter” or simply “converter”) produces gammas and heat under irradiation from the electron beam source. A fluid coolant, such as water, exports heat from the gamma converter. A second chamber (reaction chamber) holding target material exports heat with a second coolant, preferably circulating air. The target material in the reaction chamber is also optimized as particulate elements plated with precursor isotopes to optimize exposure to the gammas, facilitate free coolant fluid flow throughout the reaction chamber and target material, and to facilitate easy and rapid harvesting of the product isotopes.

The inventive method and apparatus uses a novel alloy fabricated into the form of a converter pipe, tube, or container. This functions as an electron-to-gamma converter material, and preferably comprises an optimized refractory alloy material arrayed as a thin plate over a tube made from the same alloy. The converter alloy in the plate and tube is the target for an energetic electron beam, which provides electrons that interact with the converter material to produce gamma photons. A working fluid or coolant is circulated through the converter to export heat from the electron beam. The converter plate and pipe produces gamma photons that irradiate a target material. The energy of the gamma photons produced in the converter is a function of the energy of the incident electrons: the higher the energy of the electrons, the higher the energy of the produced photons. Because the energy of the electrons can be controlled, the energy of the gamma photons can also be controlled. The spectrum of gamma photons have high enough energy to eject neutrons from the target material. Therefore, the neutrons produced also have a controllable energy spectrum. The target materials, the parent isotopes, to be irradiated by the produced gamma photons are arrayed in a target tube or capsule in the form of small beads, disks and/or oblate spheroids. The irradiated bead/disk/spheroid material consists of a substrate preferably selected from an isotope of copper, molybdenum, and/or tungsten, and a parent (precursor) isotope plated onto the surface of the substrate, such that the substrate is transmuted concurrently with the surface coating. The surface coating or interior coating (plating) comprises a rarer isotope, such as radium or selected tin, copper, barium or lanthanide isotopes. The composite target material is deployed as a particulate volume. This can be plated over to provide the protection needed for long irradiations.

The plating concepts and approaches provide a non-reactive chemical environment within the beads for the selected transmutation reactions. The plated refractory metal micro beads or disks are exposed to an engineered spectrum of penetrating and energetic gamma radiation. When the peak of the curve of the gamma spectrum is above the gamma, n threshold, of the target and as the neutrons are ejected, the desired product is made. The gamma photon spectrum is adjusted by the selecting and adjusting the thickness of the converter plate on the outside of the tube and by selecting and adjusting the energy of the incident electrons.

The target material beads/disks/oblate spheriods for the gamma radiation are contained in target material containers, such as cups or mesh baskets made from titanium, tantalum, niobium or another refractory metal or alloy of any two or more of them. The target material containers are, in turn, contained within a target capsule or housing. A coolant is pumped through and around the target material containers. When the plated isotopes used for the enclosed substrate are optimized, at least two isotopes can be produced at the same time.

After irradiation, the beads can be removed from the target material capsule, and the produced isotopes can be harvested and easily transported.

Accordingly, in contrast to the apparatus disclosed in the '993 patent (discussed in the discussion of background art, above), the apparatus of the present invention provides not only a separate converter pipe system with high heat transport and constructed from an optimized refractory alloy, but also a second chamber where a target material is plated or alloyed to a selected substrate comprising solid or hollow small beads, disks and oblate spheroids. This geometry allows a second working fluid to transport the balance of the heat from the gamma irradiation of the target chamber to be removed from the target capsule. The beads fill the target capsule to a predetermined density allowing a pumped gas or liquid to cool the target and the selected substrate. The substrate can be transmuted as well providing the second product.

These advances produce unanticipated advantages that were revealed and described in a report on the computational modeling of the inventive technique performed by the Pacific Northwest National Laboratory. The report, CRADA 262, entitled Letter Report: Electron Beam production of isotopes ²²⁵Ac, ¹¹¹In and ⁶⁴Cu, February 2007, describes the advantages of the inventive method, including the simultaneous production of indium-111, actinium-225 and copper-63 along with oxygen-15, when water is used as the coolant. Additionally, the apparatus used for producing these isotopes is far less costly than a nuclear reactor and is expected to be less expensive than a large cyclotron. Furthermore, the isotope production apparatus is compact and with proper shielding can be located in or near a clinic or hospital so that isotopes can be administered to the patient promptly. This makes many short-lived isotopes become available to clinical medicine for treatment or diagnosis of disease or to advance medical research.

In another aspect, the instant application will be seen to describe novel means to produce medical isotopes by taking advantage of five attributes of nature and the flexibility afforded by the use of plated beads or disks in a high and energetic gamma flux when the beads or disks are cooled with selected gas or liquid coolants. These five attributes are: (1) the ease with which high energy electrons can be converted to a desired spectrum of high energy gamma rays in optimized converter alloys of tungsten, rhenium, tantalum, niobium, molybdenum or other high-Z materials, or an alloy of two or more of these elements; (2) the ease with which high-energy gammas efficiently eject neutrons from the nuclei of a parent isotopes selected for transmutation when the energy of the gammas is high enough above the threshold of the giant resonance reaction in high z materials or the gamma, n reaction in lower z materials; (3) the ease with which, actinium-225, bismuth-213, indium-111, cesium-131, valuable lanthanides, and rhenium-188 (by way of example but not limitation) can be separated from parent isotopes by well-known chemical separation techniques that appear in relevant literature and publications in the art; (4) the ease with which neutrons with carefully tailored energy spectra interact with target materials to be captured optimally in target nuclei; and (5) the ease with which the beads or disks in the high energy gamma flux can be exposed to the same amount of gamma radiation in an enclosed basket when over time the beads or disks are allowed freedom of movement in the coolant stream.

Another notable advantage of the inventive device is that it can operate in two modes: one mode performing transmutations by gamma, n reactions; the other mode performing transmutations by neutron production and neutron capture reactions. When the converter is placed in proximity to a high z material such as lead, bismuth, thorium or uranium, neutrons are produced that can have a tailored spectrum to promote advantageous capture reactions.

Another advantage of the present invention is that the refractory metal or other metals comprising the substrate of the target material hold and enclose the selected rare precursor isotope(s) while each is irradiated by energetic gamma photons and/or the tailored spectrum produced neutrons.

An advantage of the particulate nature of the beads and/or disks is that it promotes efficient cooling of the plated material irradiated by the gammas and/or the neutrons by widely dispersing and spreading out the heat and exporting it from the areas of transmutation operations.

Another advantage of the particulate nature of the coated beads and/or disks is that the desired isotopes are produced under plated enclosure. This enclosed volume is the zone of the target and is where the gamma, n reaction or neutron capture reactions take place. Because the isotopes are produced within the plated target material, they may be easily removed from the surface by well-known chemical separation or elution techniques.

Yet another advantage of the present invention is that it provides efficient cooling means. During irradiation, the plated refractory metal beads or disks move in the enclosed basket under the mechanical influence of the moving coolant or working fluid, as needed. The use of a selected liquid or gas cooling medium and the particulate beads or disks allows the plated isotope of the parent material to be irradiated for indefinite long periods of time, generally averaging three times the half-life of the medical or commercial isotope produced or grown in or under the plated parent isotope (in metal form or in a convenient chemical compound or as otherwise optimized computationally).

Yet another advantage of the present invention is that the irradiated beads or disks are cooled with a selected gas or selected liquid coolant that may also produce desirable isotopes. The coolant can be optimized for isotope production because it, too, is subject to gamma, n reactions.

The preferred embodiment of this invention involves an assemblage of devices enabled and computationally optimized to comprise a system including: (1) accelerated electrons from various forms of electron accelerators (Rhodotron, Radiatron, Linac, betatron, bevatron or microtron); (2) the guided beam of accelerated electrons impacting a target of a computationally optimized converter alloy containing two or more of the following: tungsten, rhenium, tantalum, molybdenum, niobium, thorium; (3) slowing down of the electrons in a material that produces copious energetic gamma radiation (4) production of gamma photons above the binding energy of the least bound neutron(s) or least bound deuteron or alpha in the selected parent of the product isotope, (5) illuminating the parent isotope on or within the bead, plate or oblate spheroid with the gamma flux tailored or “tuned” so that one or more neutrons, deuterons or (alphas) are efficiently ejected from each nuclei (6) so that the parent isotope is conveniently transmuted into the product isotope of choice.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a cross-sectional top plan view of the isotope production apparatus of the present invention;

FIG. 2 is a cross-sectional side view in elevation of the apparatus of FIG. 1;

FIG. 3 is a cross-sectional front view of the beads or oblate spheroids of disks in a cup or basket; and

FIG. 4 is a detailed view of the plated beads, disks or oblate spheroids in a cubic matrix.

### DETAILED DESCRIPTION OF THE INVENTION

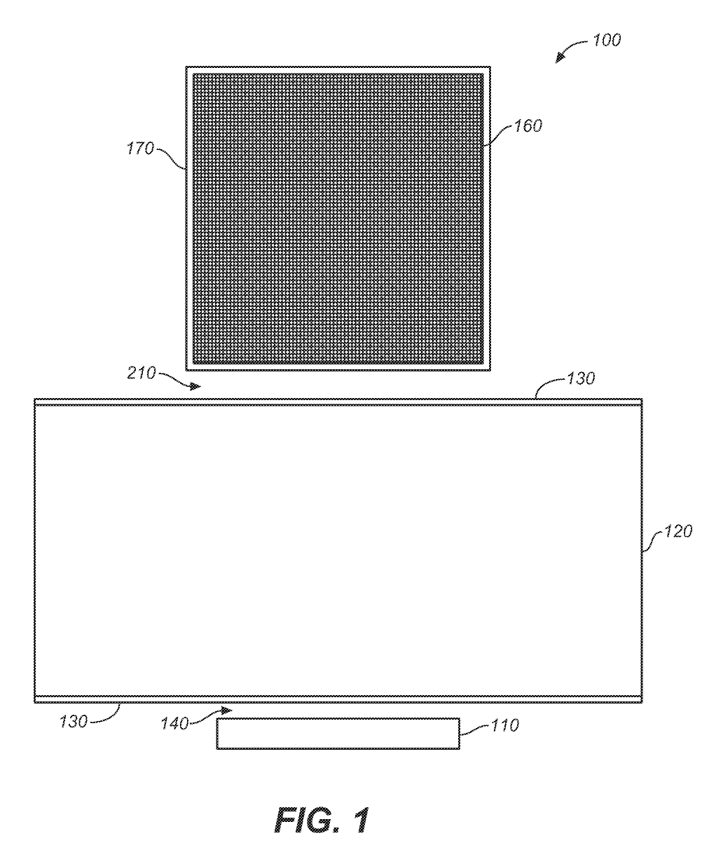

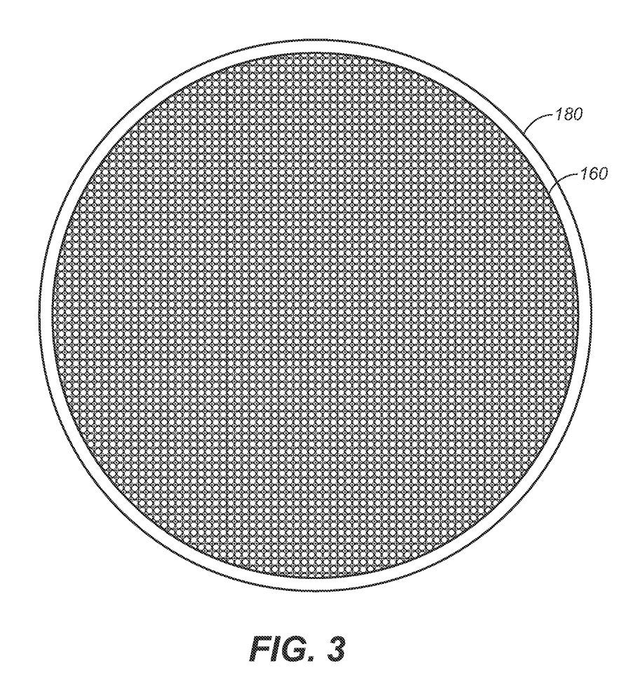

Referring to FIGS. 1 through 4, wherein like reference numerals refer to like components in the various views, there is illustrated therein a preferred embodiment of a new and improved compact apparatus for the concurrent dual transmutation of isotopes permitting production of positron emitters, beta emitters and alpha emitters using energetic electrons, generally denominated 100, herein.

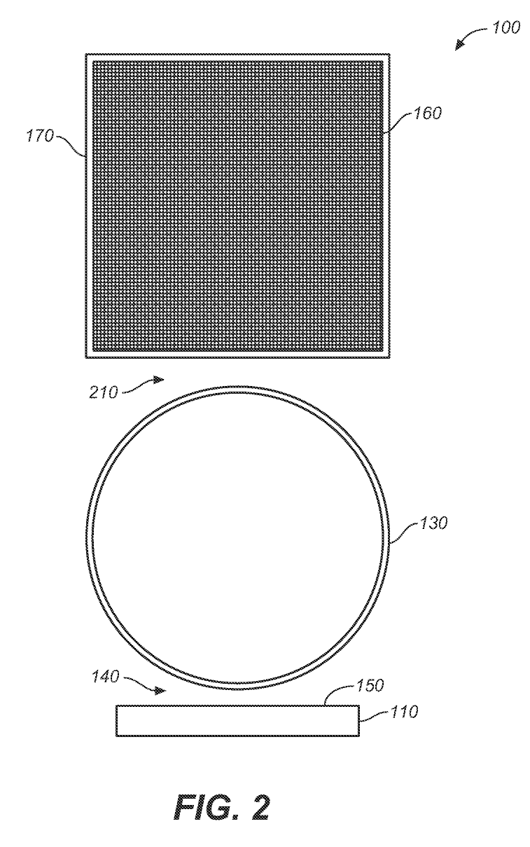

FIG. 1 shows a cross-sectional top plan view in elevation of a first preferred embodiment of the inventive apparatus, while FIG. 2 is a cross-sectional side view in elevation of the apparatus of FIG. 1. These views show that the inventive apparatus, in its most essential aspect, comprises an electron beam source 110 which generates an electron beam directed to a converter tube 120, preferably a “pipe” located closest to the beam. A selected coolant is pumped to and through the converter pipe and runs through the converter tube or pipe at high velocity to export heat from the converter wall that receives the accelerated electrons from the electron beam source. If the converter wall 130 needs to be thickened, additional plates of converter material can be inserted in the space or gap 140 between the end 150 of the beam tube and the converter pipe. While the space or gap 140 is generally quite small, it may be adjusted to provide further cooling means, such as by providing a fluid flow through the gap.

As electrons interact with the material in the converter pipe wall, energetic gammas form in the converter plate, and these gammas irradiate beads or disks 160 in a reaction chamber or target material capsule 170. The target material is disposed loosely in refractory metal pipes or tubes 180 capped at their ends by fluid permeable cups or wire mesh baskets 190. A coolant from the reaction chamber cooling system is pumped and circulated through the mesh baskets at the ends of the tubes, through and around the target material, and out the other end of the tube.

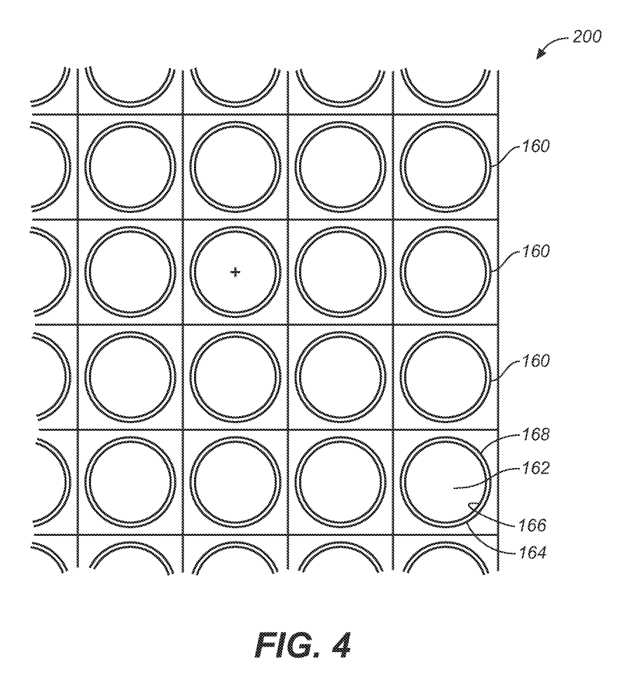

FIG. 4 provides a detailed view of the beads or disks 160 disposed in a cubic matrix 200. The beads shown may be either hollow or solid and include an interior 162 portion and a coating area 164 onto which a precursor isotope coating may be plated, either only on the interior surface 166 (in the case of a hollow substrate), or only on the exterior surface 168 (in the case of solid substrate members), or on both the interior surface and exterior surface (again, in the case of hollow substrate members).

As noted previously, the advantage of the present invention resides, at least in part, in the separation of the gamma source (i.e., the converter tube 120) from the reaction chamber (target material capsule) 170. The space 210 separating the two chambers is minimal, but it may be adjusted for optimal gamma exposure and for circulation of yet another coolant, such as air.

Surplus neutrons can be produced by gamma, n reactions by the irradiation of high-z materials, lead, bismuth, thorium, thorium alloys, and/or lead-bismuth eutectic that are irradiated with suitably energetic gamma photons produced from the incident electrons. The produced neutrons can be captured in target nuclei to make useful beta emitting isotopes such as Cesium-131 from Barium-130, Gold-198 from Gold-197, Holmium-166 from Holmium-165, Dysprosium-165 from Dysprosium-164 and Lutetium-177 from Ytterbium-176.

All of the above mentioned isotopes are needed for medical research purposes or for the treatment or diagnosis of numerous diseases. In this new approach, using the dual transmutation apparatus and with beads or disks irradiated with penetrating and energetic gammas or neutrons, valuable and desirable isotopes of at least three classes can be produced by either the gamma, n reaction or the n, gamma reaction. The classes of isotopes are positron emitter, beta emitter or alpha emitter. The apparatus is able to add or remove neutrons from target nuclei. Produced neutrons made by the gamma, can be used to irradiate targets optimized for capture one or more additional neutrons to make desired isotope products.

Now treating the apparatus elements in more detail, the wall 130 of the electron-to-gamma converter 120 is preferably an optimized refractory alloy. In the preferred embodiments, this may be tungsten (75%, +/−20%), osmium (2.5%, +/−15%), rhenium (2.5%, +/−15%), molybdenum (2.5%, +/−15%) and tantalum (2.5%, +/−15%), either alone or in some combination thereof. The material is arrayed as a plate between 0.05 and 2.5 cm in thickness. The converter is configured to facilitate the high velocity flow or circulation of a working fluid or coolant to export a significant portion (67-75%) of the heat from the electron beam. The coolant may be a liquid metal such as sodium, lithium, tin, zinc, indium, mercury and as otherwise optimized for the irradiation sequence.

Electrons in the electron beam interact with the converter material to produce gamma photons in a controllable spectrum. The energy of the produced photons is related to the energy of the incident electrons: the higher the energy of the electrons, the higher the energy of the produced photons. Thus, the energy of the gamma photons can be controlled by manipulating the energy of the incident electrons.

The gamma photons produced in the converter have high enough energy to eject neutrons from a target material 160 contained in the reaction chamber (target capsule) 170. Therefore, the neutrons produced have a calculated energy spectrum. When the electron beam provides more energy for the produced gamma photon, the neutrons have a higher energy spectrum, the peak ranging from epi-thermal to high energy (i.e., from 1000 eV to 1 MeV and above 5 Mev).

The target material for the gamma radiation is disposed and arrayed in a target capsule in the form of plated small beads, disks and/oblate spheroids, which are contained within a working fluid and kept in place by coolant permeable cups or baskets 180. The irradiated bead/disk/spheroid material consists of a substrate selected from an isotope of copper, molybdenum, and/or tungsten. This same material may be used to plate over the valuable and rare parent isotope. The exterior of the substrate is coated with the rare isotope, such as radium or selected tin or barium isotopes. If the shape of the substrate so permits, the interior may be coated as well. Thus, both the substrate and the coating are transmuted concurrently.

The shape of the substrate and coating materials is important because the target material is deployed in a particulate configuration, and each shape packs in a different manner to give rise to a different overall density of material in the target capsule. The optimum density is governed by the selection of the shape or shapes and the requirements for cooling. Some of the targets need a relatively lower overall density to allow for adequate cooling by gas or liquid means. The greatest density can be achieved using oblate spheroids; the next highest density is achieved using beads; and the least density is achieved using randomly packed disks.

A coolant is circulated through the target capsule and through and around the permeable cups or baskets. The coolant and the plated isotopes used for the substrate may each be optimized to facilitate the production of at least two isotopes at the same time. For example, copper-64 and actinium-225 can be produced simultaneously when the substrate comprises copper-65 and when the first plate comprises radium-226. After irradiation, the target materials beads can be removed from the apparatus, the actinium-225 can be eluted, and the copper-64 can be harvested.

As will be immediately appreciated, the present invention separates the electron-to-gamma converter and its heat export system from a second chamber having target material and another heat transport system. The target material is plated or alloyed to a substrate comprising solid or hollow small beads, disks and oblate spheroids, and this overall geometry facilitates highly efficient cooling that allows for prolonged irradiation cycles.

The refractory metal or other metals comprising the substrate of the target material hold the selected rare precursor isotope in a configuration optimal for exposure of a large surface areas while the precursor is being irradiated by energetic gamma photons and/or the energetic neutrons. The majority of generated gamma photons are at an energy kept high enough above the “neutron ejection threshold” or “deuteron ejection threshold” or “alpha ejection threshold” of the target nuclei when the machine is in either the gamma, n mode or in the neutron production mode.

As noted, the populations of isotope production target beads, plates, or disks are held in place in a suitable cup or wire mesh basket directly in line with the electron beam, and the beads or disks in the basket are immersed and bathed in a circulating fluid coolant. The coolant is a liquid or a gas that is enclosed in refractory metal coolant pipes, and it is pumped through the reaction chambers to remove heat produced by the electrons, the neutrons, and the gammas. The coolant pipes 190 are oriented at generally a right angle to the beam line.

The desired isotope is produced near the surface of the parent isotope on or comprising the beads/disks/oblate spheroids. This surface area is the zone of the target and is where the gamma, n reaction or neutron capture reactions take place. Because the isotopes are produced near the surface the plated target material, they may be easily removed from the surface by well-known chemical separation or elution techniques.

During irradiation, the plated refractory metal beads or disks move in the enclosed basket under the mechanical influence of the moving coolant or working fluid, as needed. The use of the selected liquid or gas cooling medium and the beads or disks allows the plated isotope of the parent material to be irradiated for indefinite periods of time, generally averaging three times the half-life of the medical or commercial isotope produced or grown in the plated parent isotope (in metal form or in a convenient chemical compound or as otherwise optimized computationally). The target beads, oblate spheroids, plates or disks are prepared from selected isotopes of tungsten, molybdenum, rhenium, tungsten, tantalum, titanium, gold, platinum, titanium, lanthanide or other alloy of any two or three or more of these or refractory metal that may be optimized computationally.

The target beads or disks are produced by spraying micro-droplets of a selected parent chemical compound to coat the interior and exterior surfaces of the target. The beads or disks are separated by size and plated by conventional electro-chemical means. By way of example, tungsten-186 micro beads, oblate spheroids, or disks can be plated with radium-226 when the radium is in an aqueous solution of radium chloride and when a direct current is applied to the metal beads or disks causing the radium-226 metal to plate the tungsten beads or disks from the aqueous solution of radium chloride. After a sufficient amount of the radium is plated upon and/or within the bead, the bead can be over-plated with another metal, such as copper or silver to cap it for the long irradiation.

The parent isotope plating provides a non-reactive chemical environment within the bead for the selected transmutation operations. In the case of radium, radium-226 is exposed to gamma radiation and produces radium-225, which decays to Actinium-225. In other cases, the plated refractory metal micro beads or disks are exposed to an engineered spectrum of penetrating and energetic gamma radiation. When the peak of the curve of the gamma spectrum is above the gamma, n threshold, the desired product is made. The gamma photon spectrum is adjusted by the selecting and adjusting the thickness of the converter plate (the thickness of the wall of the pipe receiving the incident electrons) and also selecting and adjusting the energy of the incident electrons. Desired transmutations occur in the cone of produced gamma photons.

While the numerous beads or disks holding the plated parent isotope are loosely confined and retained by a cup or wire mesh basket, gamma photons interact with the nuclei of the plated isotope within the cups or baskets to remove, as a general rule, one neutron. By way of illustration, radium-226 is plated to tungsten beads or disks. Nuclei of Radium-226 will lose a neutron when the gamma radiation is at the correct energy, near to and above the giant resonance integral of radium-226, above 8 MeV for optimum production. Each radium-226 nucleus ejects its least bound neutron, and radium-225 is produced in the plated material. The neutrons will escape the radium-226 nuclei and may be captured in tungsten material in adjacent beads or it may escape entirely. Radium-225 has a half-life of 14.9 days. It decays to Actininium-225. Actinium-225 has a half-life of 10 days. The radium-226 plated beads or disks can be exposed to gamma radiation at the correct spectrum for 10 days or so to produce an economically advantageous concentration of Actinium-225 that develops into Radium-225.

After irradiation, the beads or disks are stripped of Actinium-225 by well-known chemical separation techniques (and are returned for further irradiation in the gamma flux after radium is restored as needed). The Actinium-225 is removed from the radium-containing beads and is placed in a cow for transportation to market while highly desirable Bismuth-213 is produced from the decaying Actinium-225 in the cow.

After the many irradiations, the tungsten-186 beads or disks can be re-plated with radium-226 as needed. Re-plating may not be needed for several production cycles if elution does not require the radium to be stripped from the inert metal substrate. Alternatively, all of the radium-226 can be stripped from the tungsten and plated on fresh tungsten beads or disks, and the irradiated tungsten can then be dissolved to recover rhenium-188 after being irradiated continuously for at least 208 days. Rhenium-188 is produced by successive neutron capture in the tungsten-186. When copper-65 is used as the over-plate, valuable copper-64 will be co-produced.

With this new production technique, several classes of isotopes are produced by gamma, n transmutation reactions, alpha emitters, and positron emitters when the device is in this mode; and when in the other mode, another class of isotopes (beta emitters) is produced by neutron capture reactions.

In the above-described example, the beads or disks are tungsten-186 plated with radium-226 and over-plated with copper-65. The isotopes produced are Rhenium-188 by successive neutron capture in Tungsten-186 and Actinium-225 by photo-dissociation of Radium-226 to Radium-225 which decays in 14.9 days to Actinium-225 and copper-64 by gamma, n on copper-65. A high energy gamma flux tailored to the correct resonance energy of the targeted plated parent isotope is directed on the selected targets. Again, the beads or disks are arrayed loosely in an enclosed wire mesh “basket”, an enclosed container, permitting continuous cooling of the beads or disks by forced liquid or forced compressed gas cooling. The gas or liquid coolant transports heat from the beads or disks so that the exposure to the gamma radiation can be continuous and long-term. The beads or disks move randomly in the coolant stream in a mixture that is never less than 36% coolant or more than 64% beads or disks when the beads or disks are generally spherical, while it is up to 84% target when the beads are the oblate spheroid shape. In some preferred embodiments, the ratio of spherical beads or disks to coolant is in a ratio of 70%-30% coolant and 70%-30% beads or disks, depending upon the need for heat transport away from the transmutation vessel.

Because the high energy electrons from the electron beam interact within the first millimeters of the converter material pipe, most of the heat is produced in this region. The heat is removed by pumping the most efficient heat transfer fluid through this pipe and changing out the selected exterior converter material plate(s) before the first pipe starts to be ablated by the electron beam. A second tube encloses a selected coolant to cool the target materials. This two tube geometry assures adequate cooling and a maximum freedom of movement for the spheroids, beads or disks in the cup or basket so that each bead, disk or oblate spheroid will receive the same average exposure to the incident gammas. The packing configuration of the beads or disks permits a significant flow of gas coolant or liquid coolant through the basket enclosing the beads or disks in the frustum of the maximum gamma flux behind the converter. This movement allows a continuous and random mixing of the spheroids, beads or disks so that each bead receives almost the same average dose of incident gamma radiation over time as any other bead. The gamma radiation has the highest flux in regions closest the area in which the converter material reacts with the incident electrons. Because the beads are free to move to a predetermined extent, the gamma irradiation is averaged over time.

Again, as noted, the beads or disks are cooled with a selected gas or selected liquid coolant that may also produce desirable isotopes. And because the liquid or gas coolant will also be subjected to gamma, n reactions, it too can be selected and optimized for isotope production. For example, when ammonia and water are used as coolants, they will produce some N-13 and O-15 as a result of the gamma flux. These are valuable positron emitting isotopes. Carbon Dioxide (CO₂) is a suitable gas coolant and produces some Carbon-11 in a high gamma flux, likewise a valuable short lived positron emitting isotope. When a high-z material plug occupies a portion of the interior of the first pipe, neutrons will be produced and a neutron spectrum becomes available to irradiate target materials to produce short half-life beta emitters. The neutrons are captured in the targets and the composition of the target can enhance production by the inclusion of spectrum-shaping hydrides as part of the beads. This is accomplished by having titanium hydride, yttrium hydride or other selected lanthanide hydrides as the target or a portion of the bead work target.

For the simplest and preferred embodiments, the use of compressed air, helium, or nitrogen is preferred as a coolant in the transmutation tubes surrounding the target material in the target capsule, and water is the preferred coolant flowing through the converter tube.

The beam of electrons is energized to the optimal level of tens of millions of electron volts so that the gamma spectrum produced in the converter material will produce gamma, n, gamma 2n reactions or gamma alpha reactions desired for a particular transmutation. The parent isotope plated on, under or within the metal micro bead substrate is transmuted by gamma, n gamma, 2n or other desired effects. The metal beads or disks may comprise tungsten-186, rhenium-185, gold-197, titanium-47 copper-65 or molybdenum-100, by way of example, though not limitation. The beads or disks provide a substrate upon which a thin layer of an optimal precursor material, such as radium-226, copper-65, or tin-112, for example, can be electro-plated. The rare isotope can be plated over by silver or copper or other selected material. The beads or disks preferably have diameters in the tenths of centimeters, and the thickness of the plating is adjusted for optimal isotope production and generally falls in a range of thickness in the hundredths of centimeters.

The target material beads or disks are cooled by pressurized gas such as air, helium, carbon dioxide or nitrogen, or by light water, ammonia or a liquid metal such as sodium, potassium, sodium potassium eutectic, lead, bismuth or lead bismuth eutectic or preferably by tin or zinc. The basket or cylindrical mesh containing the target material is perforated and coolant freely flows through the material under the force of a pump or pumps; however, the mesh is impenetrable by the beads or disks. Thus, the beads are agitated and move randomly in three dimensions while being cooled. The flow of the coolant is energetic to encourage non-laminar flow in the basket so that the beads or disks continuously change position and orientation with respect to one another and to the incident beam of gamma photons. The movement of the beads or disks in the cylindrical target area generally ensures that each bead has the same average exposure to the incident gamma radiation that transmutes isotopes by selected gamma reactions.

The micro beads or disks provide a volume from which the produced isotope is efficiently harvested. The volume allows for efficient chemical separation and recovery of the valuable quantities of the produced isotopes after any over plate is stripped away. Having a comparatively large surface area for the chemical elutant or solvent to remove the desired isotope produced from the gamma, n reactions in the plated parent isotope enhances the economic efficiency of the production techniques disclosed in this application.

The irradiated beads or disks can be easily removed from the device at any time after the electron beam is de-energized. The bead basket can be sent to a chemical separation facility or radio-pharmacy firms for recovery of the generated or produced isotopes. The beads or disks can conveniently be transported and then chemically separated into cows (lead flasks) commonly used in the industry.

Summarizing, high energy neutrons or gamma photons transmute rare and expensive precursor isotopes, such as copper-65, tin-112 or radium-226, plated to the surface of a refractory metal micro-bead or disks. The ratio is preferably 2-4 parts plated material to 8-12 parts substrate material by volume with one part over plate. The thickness of the plating is in the hundredths of millimeter range. The refractory beads or disks can be made from selected isotopes as well to co-produce valuable isotopes.

A gamma flux, appropriately optimized to the correct spectrum, causes neutrons in the plated metal isotope to be ejected, transmuting the parent plated isotope over the surface of the refractory metal beads or disks. Thus, highly desirable radioisotopes form on surface plated layer over the titanium, tungsten, molybdenum, tantalum, rhenium or gold micro-beads or disks. Additionally valuable radio-isotopes form or grow in the portion of the bead below the plated isotopes by secondary n, gamma reactions.

The irradiated beads or disks can be placed in cows after they have been irradiated for approximately three half lives of the desired isotope product or a shorter time as may be computationally optimized when many isotopes are being co-produced. The small radius of the beads or disks provides a comparatively large surface area for chemical separation or elution reactions. After separation or elution, the products can be placed in a sealable lead beaker a transportation container, known as a “cow” by the radio-pharmaceutical industry. Unlike other means and methods of isotope production, neither a capital intensive reactor or nor a capital intensive cyclotron is needed for the production of the desired product isotopes. Here, a high energy electron accelerator is used. Products may be planed to exclude undesirable and unstable isotopes making the production technique available for use in clinics and hospitals.

If higher power densities are required for the application selected then the device could have a liquid metal cooling system that increases the rate of heat transfer from the electron beam target area and gamma, n target area to external heat exchangers permitting continuous operation for long periods of time and extending the operating life of the device. Under most duty cycles the heat can be managed by commonly available liquid or gas coolants such as water and air.

In the preferred embodiment, depicted in FIGS. 1-4, cooling of the beads or disks is accomplished efficiently with abundant and inexpensive compressed air or pumped water. The incoming electrons are slowed down in the initial target, the optimized converter. The slowing down takes place in the converter, which comprises an optimized refractory alloy to produce gammas known as Bremsstrahlung radiation. These Bremsstrahlung gammas are the product of slowing down interactions between the atoms of the optimized converter and the incident electrons. The spectrum of the outgoing gammas can be optimized to match the desired gamma spectrum that maximizes neutron production by gamma, n reaction in the target's parent isotope. The initial target or converter can be a pipe with wall thickness of 0.1 to 3.5 cm or as otherwise constructed to allow plates to be placed between the beam tube and the first converter pipe. In addition, the converter pipe is computationally optimized to have an interior diameter of 0.1 to 3.5 cm or such other thicknesses as are optimized computationally, to transport the gas coolant, air, argon, helium, carbon dioxide, nitrogen coolant, or the selected liquid coolant, with water being the preferred embodiment. The interior of the converter pipe receives and physically transports the selected heat transport fluid (converter pipe coolant).

The beads or disks are contained in a wire mesh basket made of refractory metal wire mesh inside a second pipe. The electrons impact the converter and are slowed down by the tungsten or optimized refractory alloy, producing a continuous spectrum of gamma photons whose peak is tailored to match the gamma absorptive resonance of the isotope to be transmuted in the secondary target area by gamma, n reactions. Managing the flux of the gammas produced and the spectrum of the gammas produced is accomplished by carefully controlling the energy of the incoming elections and by changing the geometry of the converter, e.g., the thickness of the pipe wall, to favor the production of energetic gammas at the most efficient spectrum for effecting the desired transmutations. The produced gammas interact with nuclei of the selected target isotope plated to the interior or exterior surface of the bead, plate or oblate spheroid. The gamma photons cause neutrons to be ejected from the nuclei of the target neutron producing materials in predicable amounts. The various examples disclosed in this patent application are generally called embodiments of a dual transmuter bead production process. One common component of the innovative method and apparatus is the high energy electron source that provides the highly energetic electrons that interact with the converter to produce copious number of energetic gamma photons by Bremsstrahlung or braking radiation in the gamma emitting converter material. The electron source supplies a high flux of electrons to produce a tunable and coherent gamma flux. Here the output of the energetic photons is a function of the interactions in the primary target. This gamma flux is a function of the number of high energy electrons that are slowed down by the fields near and around the nuclei of the converter, the primary target.

For the production of Actinium-225, the selected beads or disks are electro-plated with radium-226. For the production of indium-111, the selected beads or disks are electro-plated with the tin isotope, tin-112. For the production of copper-64, the selected beads or disks are electro-plated with copper-65.

The plated beads or disks are exposed to the gamma photons or neutrons at the optimized spectrum for approximately three times the half-life of the desired isotope product. Accordingly, in the case of Actinium-225, the exposure period is approximately 10 days. For Indium-111, the exposure period is approximately six days. For copper-64 the exposure period is approximately 38.1 hours, or such period as is computationally optimized. To produce Rhenium-188 efficiently, the total irradiation time of the tungsten-186 substrate, the inner component of the beads oblate spheroid or disks, should be approximately of 210 days.

When the beads or disks are plated with radium, Bismuth 213 can be eluted from the Actinium-225 that is eluted first from the radium plated beads or disks. From Tin-112 plated beads or disks, Indium 111 is eluted. Copper-64 is produced from beads or disks plated with Copper-65.

After the desired plated isotope has been exposed to the gamma flux for three or so half-lives, the beads are milked for the desired isotopes, and the elutant cow can be refreshed with newly irradiated beads or disks. The previously milked beads or disks can be returned to the gamma generator for further production. After many cycles the tungsten-186 substrate will have captured neutrons (that were ejected from nuclei of the plated material) and will contain some tungsten-188 that decays to rhenium-188. The more valuable outer coat can be removed by a selected aqueous or organic solvent and the tungsten containing the valuable rhenium-188 can be dissolved in a second solvent so that the rhenium-188 can be recovered. Molybdenum-99m can be also recovered from molybdeneum-100 when it is used instead of another refractory metal as the substrate.

As will be appreciated from the foregoing, an object of the present invention is the provision of a practical and safer way to produce a set of useful and desirable medical isotopes: alpha emitters such as Bismuth-213, useful for the treatment of cancer and infectious disease; beta emitters, such as Rhenium-188 useful for the treatment of heart disease and circulatory disorders; Indium-111, used for the treatment and diagnosis of cancer and for many applications in genetic and medical research; and positron emitters copper-64, made from gamma, n reactions from Copper-65; Strontium-83 from Strontium-84; Cesium-131 from Barium-130; lanthanides, such as Holmium-166 from Holmium-165; Lutetium-177 from Ytterbium-176; and many others by neutron capture. Examples of alpha emitters include: Bismuth-212 from Actinium-225 from Radium-226; positron emitter Copper-64 from Copper-65 by gamma, n or Copper-64 from Copper-63 by neutron capture; and for beta emitters Indium-111 from Tin-112 by gamma, n and beta emitters by neutron capture such as Cesium-131 from Barium-130 and the lanthanides as set out above.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An apparatus for producing a plurality of isotopes in a single radiation cycle, comprising:
an electron beam source;
a converter having a tube wall spaced apart from said electron beam source for receiving electrons from said electron beam source and converting the energy of the electrons into a tailored spectrum of gamma radiation;
a first cooling system for exporting heat from said converter as heat is generated during a radiation cycle;
a reaction chamber physically separated from said converter;
a second cooling system for exporting heat from said reaction chamber; and
a volume of precursor isotope target material disposed in said reaction chamber for receiving the gamma radiation generated in said converter.

2. The apparatus of claim 1, wherein said converter wall is fabricated from an optimized refractory alloy including a metal selected from the group consisting of tungsten, rhenium, molybdenum, tantalum, niobium, osmium, and any combination thereof.

3. The apparatus of claim 2, wherein said tungsten is in the amount of 75%, +/−20% by weight, said rhenium is in the amount of 2.5%, +/−15% by weight, said molybdenum is in the amount of 2.5%, +/−15% by weight, said niobium is in the amount of 2.5% +/−15% by weight, said osmium is in the amount of 2.5% +/−15% by weight, and said tantalum is in the amount of 2.5%, +/−15% by weight.

4. The apparatus of claim 2, wherein said converter wall is between 0.05 cm and 3.5 cm in thickness and is adjustable.

5. The apparatus of claim 1, wherein said converter includes selectively removable plates for varying the thickness of said converter wall.

6. The apparatus of claim 1, wherein said converter is configured as a pipe and wherein said first cooling system comprises a fluid coolant pumped through said converter pipe.

7. The apparatus of claim 6, wherein said coolant is selected from the group consisting of water, ammonia, and liquid metal.

8. The apparatus of claim 7, wherein said liquid metal is selected from the group consisting of sodium, lithium, indium, tin, zinc lead, bismuth, and lead bismuth eutectic.

9. The apparatus of claim 1, wherein said target material comprises a plurality of particulate members selected from the group consisting of beads, disks, oblate spheroids, and any combination thereof.

10. The apparatus of claim 9, wherein each of said particulate members includes a substrate plated with at least one precursor isotope coating.

11. The apparatus of claim 10, wherein said particulate members are disposed loosely in fluid permeable refractory metal containers.

12. The apparatus of claim 11, wherein said refractory metal containers are disposed in refractory metal tubes, and wherein a coolant fluid from said second cooling system circulates through said refractory metal tubes.

13. The apparatus of claim 12, wherein said substrate is selected from an isotope of copper, tungsten, molybdenum, rhenium, tungsten, tantalum, titanium, gold, platinum, the lanthanides, and any combination thereof.

14. The apparatus of claim 13, wherein said precursor isotope coating comprises at least one rare isotope selected from the group consisting of radium-226, barium-130, and tin-112.

15. The apparatus of claim 10, wherein said particulate members are disposed in refractory metal containers directly in line with the electron beam and said refractory metal containers are disposed in refractory metal coolant pipes through which coolant from said second cooling system is circulated.

16. The apparatus of claim 15, wherein said particulate members are disposed in said refractory metal container so as to be able to move under the mechanical influence of said coolant.

17. The apparatus of claim 10, wherein said particulate members further include an over-plate metal disposed on the surface of said precursor isotope coating, said over-plate selected from the group consisting of copper and silver.

18. A method of producing short-lived medical and commercial isotopes of three kinds, including alpha emitters, beta emitters, and positron emitters, using accelerated electrons to produce Bremsstrahlung radiation such that two or more reactions simultaneously transmute one or more parent isotopes, said method comprising the steps of:
(a) irradiating one or more parent isotopes with gamma irradiation to produce gamma, n transmutations;
(b) irradiating one or more parent isotopes with gamma radiation to promote gamma, 2n transmutations;
(c) irradiating one or more parent isotopes with gamma radiation to promote gamma, alpha transmutations; and
(d) exposing one or more parent isotopes to neutrons for capturing neutrons generated by gamma, n or gamma, 2n reactions.

19. A method of producing short-lived medical and commercial isotopes in three classes, including alpha emitters, beta emitters, and positron emitters, comprising the steps of:
(a) providing an isotope production apparatus having an electron beam source, a electron-to-gamma converter with a tube wall spaced apart from the electron beam source and positioned to receive electrons from said electron beam source and to convert the energy of the electrons into a tailored spectrum of gamma radiation, a first cooling system for exporting heat from the electron-to-gamma converter as heat is generated during a radiation cycle, a reaction chamber physically separated from the electron-to-gamma converter, a second cooling system for exporting heat from the reaction chamber, and a volume of precursor isotope target material disposed in the reaction chamber for receiving the gamma radiation generated in the electron-to-gamma converter;
(b) producing accelerated electrons in the electron beam source to produce Bremsstrahlung radiation in the electron-to-gamma converter;
(c) directing the gamma radiation produced in the electron-to-gamma converter to the reaction chamber and irradiating one or more parent isotopes with gamma irradiation to produce one or more of gamma, n transmutations, gamma, 2n transmutations, alpha transmutations, and neutron capture reactions; and
(d) harvesting the commercially or medically valuable short-lived isotopes produced in the target material.
